(19) United States
(12) Patent Application Publication
(10) Pub. No.: US 2004/0212819 A1
(43) Pub. Date: Oct. 28, 2004

(54) Image printing system, image printing method and image printing apparatus

(75) Inventors: Hiroyasu Nishimura, Tokyo (JP); Kenji Okuyama, Tokyo (JP); Tomoyuki Ishii, Tokyo (JP); Chohiko Fukuoh, Tokyo (JP); Yuuichi Kawamura, Tokyo (JP); Masayuki Yasukaga, Tokyo (JP)

Correspondence Address: MUSERLIAN AND LUCAS AND MERCANTI, LLP, 475 PARK AVENUE SOUTH, NEW YORK, NY, 10016, US

(73) Assignee: Konica Minolta Business Technologies, Inc., Tokyo (JP)

(21) Appl. No.: 10/803,644

(22) Filed: Mar. 18, 2004

(30) Foreign Application Priority Data
Apr. 8, 2003 (JP) JAPAN/2003-104567

(51) Int. Cl. G06F 15/00; G06F 3/12; G06F 17/00

(52) U.S. Cl. 358/1.13; 358/1.16; 715/511

(57) ABSTRACT

This invention provides an image printing system, method, apparatus, and the like which can shorten the data transfer time from an information processing apparatus to an image printing apparatus and can also shorten the printing time in the image printing apparatus when differential printing is performed. According to the image printing system of the invention, when differential printing is to be performed, a difference comparison/detection unit detects the difference between image information after a revision and image information before the revision which is recorded in advance. A printing information converting unit converts the image information of a portion in which the difference is detected into printing information, and outputs the printing information after the revision. A printing unit prints an image on the basis of this printing information.

### BACKGROUND OF THE INVENTION

1. Field of the Invention

The present invention relates to an image printing system, image printing method and image, printing apparatus which can be suitably applied to a multifunction apparatus, printer, and the like which print images on the basis of image information corresponding to a plurality of pages.

2. Description of the Prior Art

Conventionally, an image printing system designed to print images on the basis of image information corresponding to a plurality of pages includes, for example, a computer and printer.

In such an image printing system, when an image is to be printed on the basis of image information, the image information is input from the computer, which in turn transfers the image information to the printer. The printer bitmaps the image information transferred from the computer into printing information (bitmap data), and prints an image on the basis of the printing information after the conversion.

Recently, data converted into printing information is stored in a data storage unit, and the stored image information is reused when some revision is made to the image information. For example, this image information is used for differential printing. In this case, differential printing is the operation of printing only revised pages when image information is partly revised.

For example, there has been proposed a printing processing apparatus having a differential printing function which prints only revised pages when image information is partly revised (see, for example, Japanese Unexamined Patent Publication No. 2000-194518, pp. 4-9, FIGS. 1 and 6).

In this case, the printing information of a printed document is stored in the data storage unit of the printing processing apparatus. When the image information of this document is partly revised, and only revised pages are to be printed, the image information after the revision is transferred from the computer serving as an information processing apparatus to the printing processing apparatus. The printing processing apparatus converts the image information, received from a printing information converting unit (image information bitmapping unit) which converts image information into printing information, into bitmap data, and compares the bitmap data after the conversion with the bitmap data stored in the data storage unit to detect revised pages. The printing processing apparatus then prints the detected pages. With this operation, only the revised pages can be efficiently printed, and unnecessary use of printing paper sheets can be reduced, thereby achieving resource saving. This can also avoid the cumbersome operation of searching for revised portions and prevent oversights that occur when, for example, a visual search is made for revised portions.

In addition, there has been proposed an image printing apparatus which has a differential printing function of printing only revised pages and is comprised of a host apparatus and printer (see, for example, Japanese Unexamined Patent Publication No. 2001-341365, pp. 1-2, FIGS. 1 and 2).

In this case, as in patent reference 1 described above, the bitmap data of a printed document is stored in the image information storage unit of the printer. When the image information of this document is partly revised, and only revised pages are to be printed, the image information after the revision is transferred from the host apparatus to the printer. The printer compares the received image information with the bitmap data stored in the image information storage unit to detect revised pages. The printer then prints the revised pages.

According to the prior arts disclosed in the above two references, bitmap data printed once is stored in the data storage unit in the image printing apparatus, and corresponding image information is revised. When only revised pages are to be printed, all the image information after the revision is transferred from the computer (or host apparatus) to the printing processing apparatus. The printing processing apparatus (or printer) converts the image information into bitmap data and compares it with the bitmap data before the revision to detect revised pages. This makes it necessary to transfer a large amount of data from the computer (or host apparatus), and it takes much time to transfer the data. In addition, since the printing processing apparatus (or printer) converts all received image information after a revision into bitmap data and compares it with the bitmap data before the revision, a heavy load is imposed on the printing processing apparatus (or printer), resulting in slowing down the printing processing. In a system having a plurality of computers, in particular, since a printer serving as a shared device must perform bitmap processing of a large amount of image information, difference comparison/detection, and the like, the printing processing tends to be slowed down.

### SUMMARY OF THE INVENTION

The present invention has been made to solve the above problems in the prior art, and has as its object to provide an image printing system and image printing method and apparatus which can shorten the data transfer time from a printing information converting unit to a printing unit and can also shorten the printing time when differential printing is performed.

In order to achieve the above object, according to the first, aspect of the present invention, there is provided an image printing system which causes a printing unit to output an image on the basis of input image information corresponding to a plurality of pages, comprising a printing information converting unit which converts the input image information corresponding to the plurality of pages into printing information, a storage unit which stores image information corresponding to a plurality pages in advance, a difference comparison/detection unit which compares the input image information corresponding to the plurality of pages with the image information corresponding to the plurality of pages stored in the storage unit on a page basis, and a control unit which controls the printing unit to output the printing information converted by the printing information converting unit, wherein page-based image information which is determined to be different by the difference comparison/detection unit is converted into printing information by the printing information converting unit, and the printing unit outputs the image information as an image on the basis of the converted printing information.

According to the second aspect of the present invention, in the image printing system described in the first aspect, when image information corresponding to a plurality of pages is to be output onto one output paper sheet, all page-based image information which includes page-based image information which is determined to be different by the difference comparison/detection unit is converted into printing information by the printing information converting unit, and the printing unit outputs an image on the basis of the converted printing information.

According to the third aspect of the present invention, there is provided an image printing system in which at least one information processing apparatus to which image information corresponding to a plurality of pages is input and an image printing apparatus including a printing unit which prints an image on the basis of the input image information corresponding to the plurality of pages are connected to each other through a network, the information processing apparatus including a printing information converting unit which converts the input image information corresponding to the plurality of pages into printing information, a storage unit which stores image information corresponding to a plurality pages in advance, a difference comparison/detection unit which compares the input image information corresponding to the plurality of pages with the image information corresponding to the plurality of pages stored in the storage unit on a page basis, and a control unit which controls the printing unit of the image printing apparatus to output the printing information converted by the printing information converting unit, wherein page-based image information which is determined to be different by the difference comparison/detection unit is converted into printing information by the printing information converting unit, and the printing unit outputs the image information as an image on the basis of the converted printing information.

According to the fourth aspect of the present invention, in the image printing system described in the third aspect, the difference comparison/detection unit compares the image information corresponding to the plurality of pages stored in the storage unit with revised image information corresponding to a plurality of pages, and detects image information of a revised page portion, the printing information converting unit converts the image information of the revised page portion detected by the difference comparison/detection unit into printing information, and the control unit outputs the printing information of the revised page portion to the image printing apparatus.

According to the fifth aspect of the present invention, in the image printing system described in the fifth aspect, when image information corresponding to a plurality of pages is to be output onto one output paper sheet, all the page-based image information including page-based image information which is determined to be different by the difference comparison/detection unit is converted into printing information by the printing information converting unit, and an image is output from the printing unit of the image printing apparatus on the basis of the converted printing information.

According to the sixth aspect of the present invention, there is provided an image printing apparatus which is connected, through a network, to at least one information processing apparatus to which image information corresponding to a plurality of pages is input, comprising a printing information converting unit which converts the input image information corresponding to the plurality of pages into the printing information, a data storage unit which stores the converted printing information; and an image printing unit which, when the input image information corresponding to the plurality of pages includes a page which needs to be revised, prints images corresponding to a plurality of pages on the basis of printing information converted by the printing information converting unit from image information from the information processing apparatus which revises the image information of the corresponding page and includes a difference comparison/detection unit which compares the revised image information corresponding to the plurality of pages with the image information corresponding to the plurality of pages stored in the storage unit on a page basis to detect a difference, wherein page-based image information which is determined to be different by the difference comparison/detection unit is converted into printing information by the printing information converting unit, and the image printing unit outputs the converted printing information.

According to the seventh aspect of the present invention, in the image printing apparatus described in the sixth aspect, the image printing apparatus prints an image on an output paper basis on the basis of the printing information of a revised portion which is converted by the printing information converting unit.

According to the eighth aspect of the present invention, in the image printing apparatus described in the sixth aspect, when image information corresponding to a plurality of pages is to be output onto one output paper sheet, the image information corresponding to the plurality of pages is arranged on one surface or obverse and reverse surfaces of one output paper sheet.

According to the ninth aspect of the present invention, there is provided an image printing method of outputting an image on the basis of input image information corresponding to a plurality of pages, comprising the printing information converting step of converting the input image information corresponding to the plurality of pages into printing information, the storage step of storing image information corresponding to a plurality pages, and the comparison step of comparing the input image information corresponding to the plurality of pages with the image information corresponding to the plurality of pages stored in the storage unit on a page basis, wherein page-based image information which is determined to be different in the comparison step is converted into printing information in the printing information converting step, and is output as an image.

According to the 10th aspect of the present invention, there is provided a computer-readable storage medium which stores a program for controlling an information processing unit to which image information corresponding to a plurality of pages is input, the program including the printing information converting step of converting the input image information corresponding to the plurality of pages into printing information, the storage step of storing image information corresponding to a plurality pages, and the comparison step of comparing the input image information corresponding to the plurality of pages with the image information corresponding to the plurality of pages stored in the storage step on a page basis, wherein the information processing unit is controlled to convert page-based image information which is determined to be different in the comparison step into printing information in the printing information converting step, and to output the converted printing information.

As is obvious from the respective aspects described above, according to the present invention, in differential printing in which only a portion in which image information is revised is printed, the amount of data transferred from the printing information converting unit to the printing unit can be reduced, and hence the data transfer time can be shortened. In addition, since the printing information converting unit converts image information into printing information, the load imposed on the image printing apparatus can be reduced, and the printing time can be shortened.

In addition, when image information corresponding to a plurality of pages is converted into printing information, and an image is to be printed on the basis of the printing information after the conversion, only a portion in which image information is revised can be printed. This makes it possible to easily replace part of specifications. In this case, a large number of pages need not be printed, and hence printing paper sheets can be saved.

Furthermore, function setting can be done by the printer driver, and a plurality of pages can be properly imposed.

The present invention can be very suitably applied to differential printing in a copying machine, printer, and the like which prints images on the basis of image information corresponding to a plurality of pages.

### BRIEF DESCRIPTION OF THE DRAWINGS

FIG. 1 is a view showing the schematic arrangement of an image printing system according to an embodiment of the present invention;

FIG. 2A is a block diagram showing an example of the internal arrangement of the image printing system;

FIG. 2B is a block diagram showing another example of the internal arrangement of the image printing system;

FIGS. 3A and 3B are views showing two examples of image information which is partly revised, in which FIG. 3A shows an example before the revision and FIG. 3B shows an example after the revision;

FIG. 4 is a view showing a print example obtained by imposing a plurality of pages; and

FIG. 5 is a flow chart showing an example of the operation to be performed in differential printing.

### DETAILED DESCRIPTION OF THE PREFERRED EMBODIMENT

An image printing system and image printing method and apparatus according to a preferred embodiment of the present invention will be described in detail below with reference to the accompanying drawings.

In the image printing system according to an embodiment of the present invention, at least one information processing apparatus, which is used to input and edit image information, and an image printing apparatus, which prints images corresponding to a plurality of pages on the basis of the printing information output from the information processing apparatus, are connected to each other through a network such as a LAN.

When image information corresponding to a plurality of pages is to be converted into printing information, and images are to be printed on the basis of the printing information after the conversion, the image information corresponding to the plurality of pages is stored in an image information storage unit. In addition, if the image information has a portion to be revised, the image information of the corresponding page is revised. The revised image information is then compared with the image information corresponding to the plurality of pages stored in the image information storage unit on a page basis, thereby detecting the image information of the revised page portion. The detected revised page portion is converted into printing information by a printing information converting unit. The printing information of the revised portion after the conversion is output as an image, thus performing differential printing. In this manner, the data transfer time from the printing information converting unit to the printing unit can be shortened, and the printing time can also be shortened.

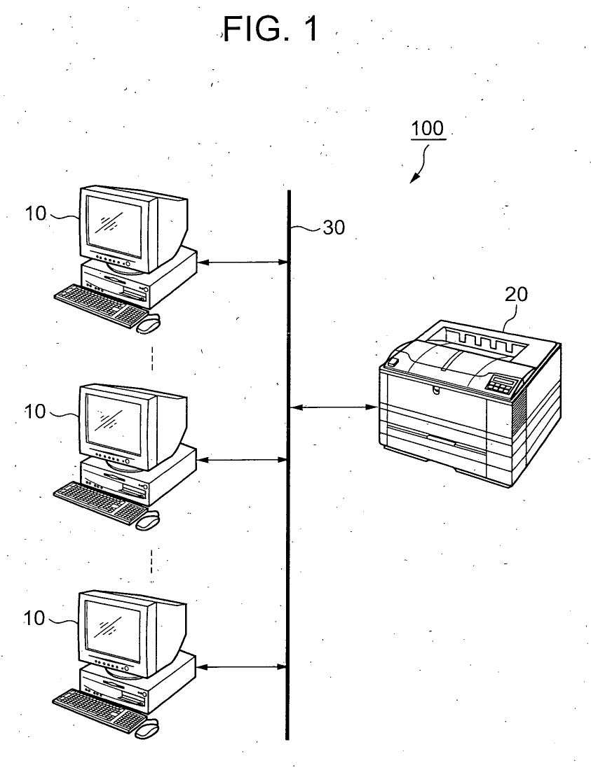

FIG. 1 is a view showing an example of the arrangement of an image printing system 100. As shown in FIG. 1, the image printing system 100 includes computers 10 serving as information processing apparatuses, a printer 20 serving as an image printing apparatus, and a network 30. In the image printing system 100, the plurality of computers 10 and the printer 20 are connected to each other through the network 30. In this case, the printer 20 is used as a shared output device.

The computer 10 is an example of an information processing apparatus and used to input and edit image information. The computer 10 is also used to input, for example, an instruction to execute a printing job (image printing job) associated with input image information. When printing is to be done, the computer 10 converts input image information into printing information (bitmap data), and transfers the converted printing information to the printer 20. The computer 10 has a printer driver for printing image information by using the printer 20. An instruction concerning differential printing can be issued by using this printer driver. The printer driver also has a difference comparison/detection function and printing information generating function.

The printer 20 is an example of an image printing apparatus, which prints an image on the basis of the image information transferred from the computer 10. Note that a multifunction apparatus may be used as an image printing apparatus.

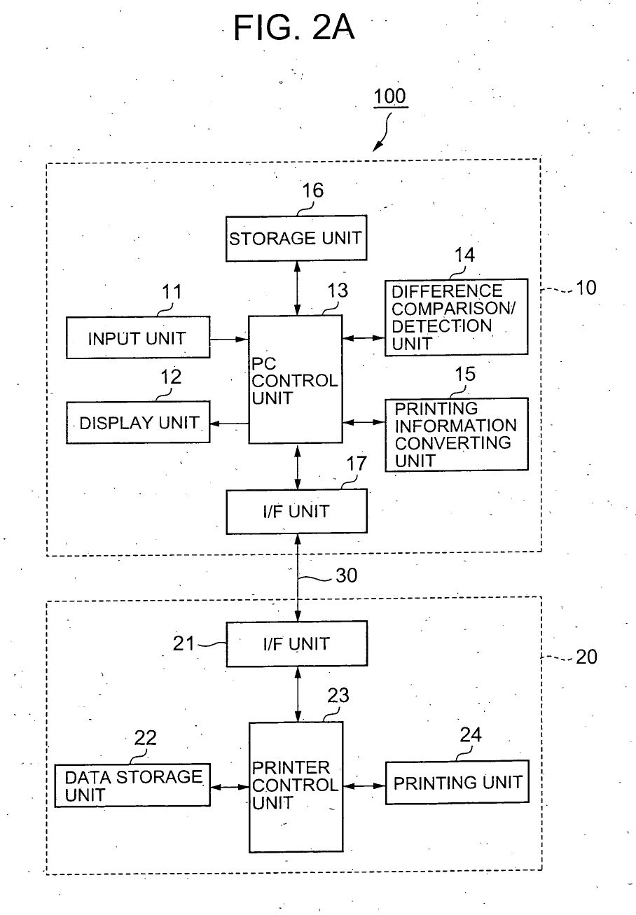

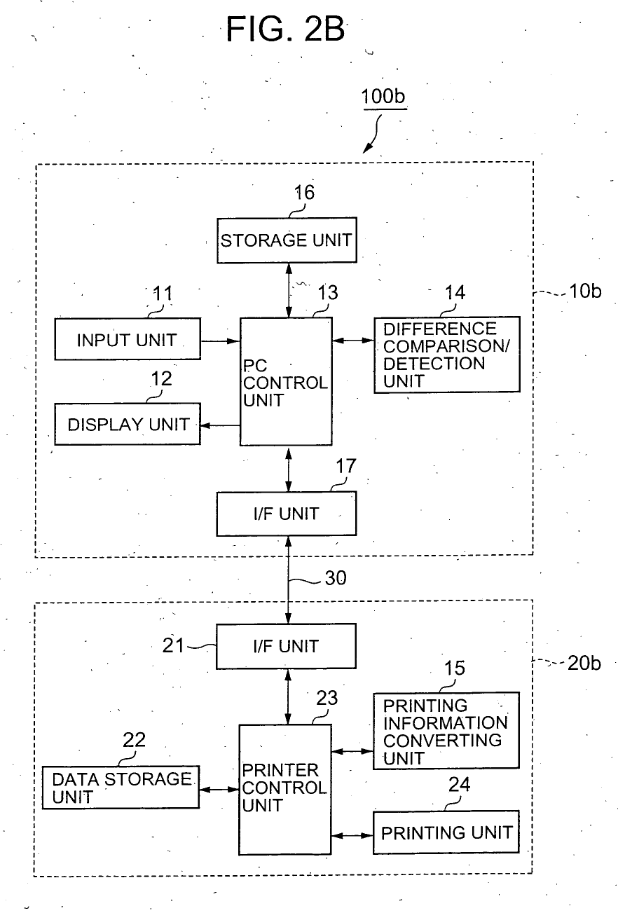

FIG. 2A is a block diagram showing an example of the arrangement of the image printing system 100. In this case, one computer 10 is connected to the printer 20 through the network 30.

As shown in FIG. 2A, the computer 10 serving as an information processing apparatus includes an input unit 11, display unit 12, PC control unit 13, difference comparison/detection unit 14, printing information converting unit 15, storage unit 16, and I/F unit 17.

The input, unit 11 includes for example, a keyboard, mouse, and the like. The user operates the keyboard, mouse, and the like to input image information such as documents and images. The input unit 11 is connected to the PC control unit 13. The PC control unit 13 displays input image information on the display unit 12. The PC control unit 13 can partly revise the image information previously input from the input unit 11 and stored in the image information storage unit.

The display unit 12 has a display such as a CRT (Cathode Ray Tube). Note that as the display unit 12, a liquid crystal panel may be used. The display unit 12 is connected to the PC control unit 13. The image information input from the input unit 11 is displayed on the screen of the display unit 12. The user, for example, edits image information or issues an instruction to print (print an image) on this screen.

The PC control unit 13 includes a CPU, ROM, and RAM (none of which are shown). The CPU controls the overall operation of the computer 10 by using the RAM as a work area in accordance with the control program information stored in the ROM.

The PC control unit 13 forms a control unit. The PC control unit 13 causes the printing information converting unit 15 to converts image information for which a print instruction is issued into printing information (bitmap data), and performs control to, transfer the printing information after the conversion to the printer 20. When an instruction to perform differential printing is issued, the difference comparison/detection unit 14 detects the difference (revised portion) between image information after a revision and image information before the revision which is stored in advance. The printing information converting unit 15 converts only the image information of the portion in which the difference is detected into printing information, and transfers the printing information after the conversion to the printer 20.

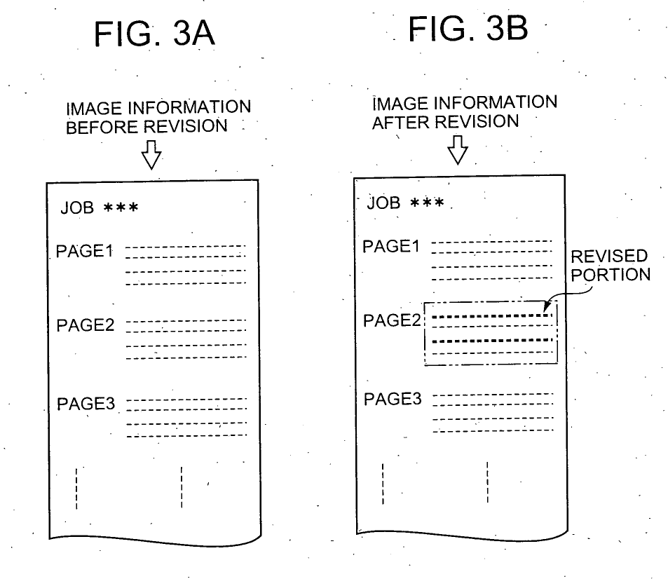

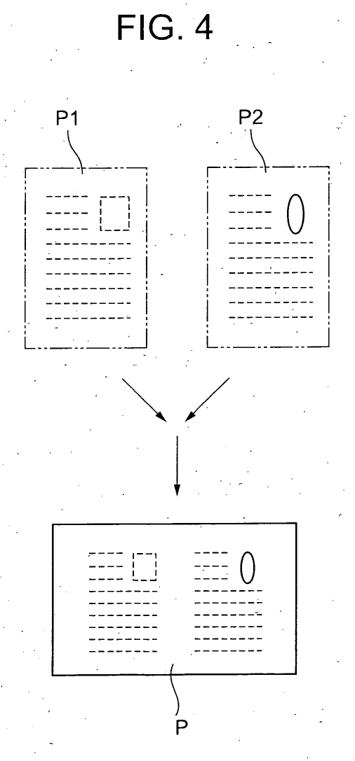

The difference comparison/detection unit 14 is formed by a printer driver. When image information is revised due to editing or the like, the difference comparison/detection unit 14 serves as a comparison unit which compares the two pieces of information before and after the revision to detect a revised portion. The difference comparison/detection unit 14 compares, for example, the image information before a revision which is stored in the storage unit 16 with the image information after the revision to detect pages having different contents (see FIGS. 3A and 3B to be described later). In differential printing in which when image information is partly revised, only a revised page is printed, when image information corresponding to a plurality of pages is to be printed on one output paper sheet (see FIG. 4 to be described later), the image information before a revision which is stored in the storage unit is compared with the image information after the revision, and the difference is detected on an output paper sheet basis.

The printing information converting unit 15 is formed by a printer driver and designed to convert image information for which a print instruction is issued into printing information (bitmap data). When differential printing is to be performed, the printing information converting unit 15 converts only the image information of a portion in which a difference is detected, thus generating printing information. In this case, for example, the image information is converted into printing information for each page in which a difference is detected or for each output paper sheet. The printing information obtained by the printing information converting unit 15 is output through the I/F unit 17.

The storage unit 16 stores image information input from the input unit 11. For example, a hard disk drive (HDD) or nonvolatile memory is used as the storage unit 16. The storage unit 16 is connected to the PC control unit 13. When printing is to be done, image information is read out from the storage unit 16, converted into printing information, and transferred to the printer 20. When differential printing is to be done, image information before a revision and image information after the revision are read out from the storage unit 16, and their difference is detected by the difference comparison/detection unit 14. The portion in which the difference is detected is then converted into printing information. This information is transferred to the printer 20.

The I/F unit 17 is an interface for connecting the computer 10 to the network 30. When printing is to be done, the printing information generated by the printing information converting unit 15 is transferred to the printer 20 through the I/F unit 17.

As shown in FIG. 2A, the printer 20 serving, as an image printing apparatus includes an I/F unit 21, a data storage unit 22, a printer control unit 23, and a printing unit 24 serving as an image printing unit. The I/F unit 21, data storage unit 22, and printing unit 24 are connected to the printer control unit 23.

The I/F unit 21 is an interface for receiving the printing information transferred from the computer 10 through the network 30. The printing information transferred from the computer 10 is received by the I/F unit 21. This printing information is transferred to the data storage unit 22.

The data storage unit 22 stores the printing information received through the I/F unit 21. The data storage unit 22 is connected to the printer control unit 23. When an image is to be printed on an output paper sheet, the printer control unit 23 reads out printing information from the data storage unit 22. The printing unit 24 then prints an image on an output paper sheet on the basis of this printing information. Note that the printing information stored in the data storage unit 22 can be reused.

The printer control unit 23 includes a CPU, ROM, and RAM (none of which are shown). The CPU controls the overall operation of the printer 20 by using the RAM as a work area in accordance with the control program information stored in the ROM. When, for example, differential printing is to be done, the printer control unit 23 controls the printing unit 24 to print an image on the basis of the image information of the revised portion which is received through the I/F unit 21. The printer control unit 23 controls the printing unit 24 to print an image for each page or each output paper sheet with respect to a revised portion.

The printing unit 24 prints an image on an output paper sheet on the basis of image data. The printing unit 24 includes, for example, a laser beam generating unit, a photosensitive drum, developing unit, transfer unit, fixing unit, and the like (none of which are shown). When an image is to be printed on an output paper sheet, the printing unit 24 prints a latent image on the charged photosensitive drum by exposing it using the laser beam generating unit on the basis of printing data. The developing unit performs developing processing by spraying toner onto the photosensitive drum. The toner, image printed by the transfer unit is transferred onto an output paper sheet by the transfer unit. The image transferred onto the output paper sheet is fixed by the fixing unit. Finally, the output paper sheet on which the image is fixed is delivered, thereby completing image printing.

FIGS. 2B is a block diagram showing another example of the arrangement of the image printing system of the present invention. An image printing system 100b is the same as the image printing system 100 in FIG. 2A in that one computer 10b is connected to a printer 20b through the network 30. In the example shown in FIG. 2B, however, the printing information converting unit 15 for bitmap conversion is provided in the printer 20b instead of the computer 10b. With this arrangement, bitmap conversion is performed by the printer 20b which is an image printing apparatus However, the overall function is the same as that of the image printing system 100 shown in FIG. 2A.

Furthermore, there may be provided an image printing system which, in addition to the printing information converting unit 15, the difference comparison/detection unit 14 and the storage unit 16 are also installed in the printer 20b.

FIGS. 3A and 3B show an example of how image information is partly revised. FIGS. 3A and 3B are illustrations of image information before a revision and image information after the revision, respectively. As shown in FIGS. 3A and 3B, pieces of image information of a plurality of pages are arranged in page order (page 1, page 2, page 3, . . . ) FIG. 3A shows the image information before the revision. Assume that of the image information before the revision, the image information of the second, page (page 2) is partly revised. FIG. 3B shows the image information after this revision.

FIG. 4 is a view showing an example of how a plurality of pages are imposed. Imposition of a plurality of pages is the function of printing image information corresponding to a plurality of pages on one output paper sheet. For example, as shown in FIG. 4, pieces of image information P1 and P2 corresponding to two pages can be reduced and printed on one output paper sheet. Operation other than that shown in FIG. 4 can also be performed. For example, image information corresponding to four pages can be printed on one output paper sheet.

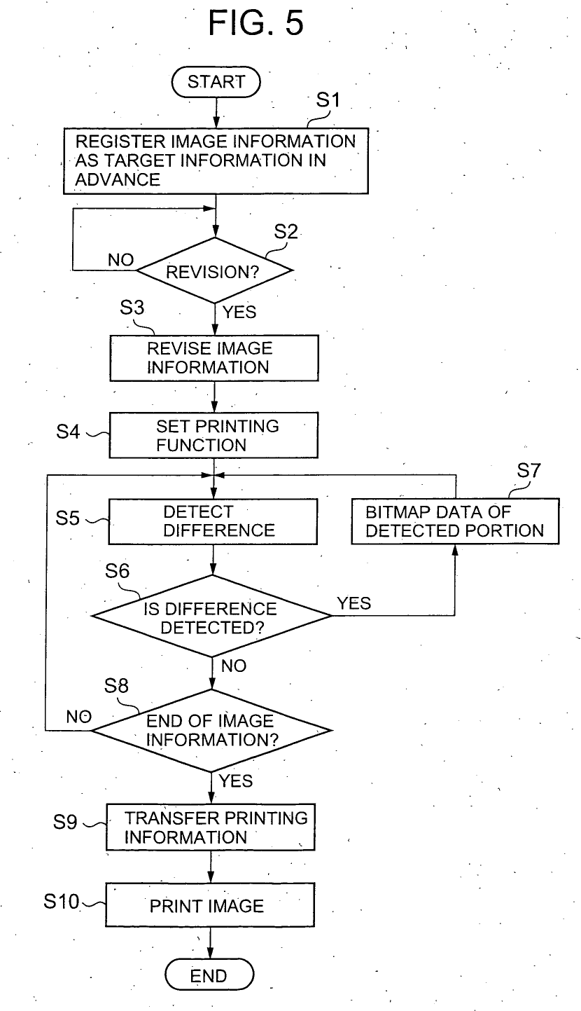

An image printing method for differential printing in the image printing system 100 will be described below with reference to FIG. 5.

FIG. 5 is a flow chart showing an example of differential printing performed in the image printing system 100.

This embodiment is based on the following premise. In the image printing system 100, when the image information of a previously printed document, regarded as image information before a revision, is partly revised, and only the revised portion is to be printed, the computer 10 causes the difference comparison/detection unit 14 to detect the difference between the image information after the revision and the image information before the revision, causes the printing information converting unit 15 to convert the image information of the portion in which the difference is detected into printing information, and transfers the printing information after the conversion to the printer 20. The printer 20 prints an image on the basis of the transferred printing information.

Under this operation condition, first of all, in step S1 in the flow chart shown in FIG. 5, image information (original) as a comparison target is registered in advance. In this case, for example, the file name of an original printed once before is registered in the computer 10. The image information of this original is regarded as image information before a revision. In this case, the image information before the revision is stored in the storage unit 16 of the computer 10.

In step S2, it is checked whether or not the registered image information of the original has been revised by the user due to editing or the like. If it is determined that the information has been revised, the image information is revised, and the image information after the revision is stored as image information after a revision in the storage unit 16 in step S3.

In step S4, a printing function concerning differential printing is set. For example, a function for two-sided printing or imposition of a plurality pages is set on the setting window provided by the printer driver, and differential printing is executed. In this case, a function for imposing a plurality of pages, i.e., printing image information corresponding to two pages onto one output paper sheet is set (see FIG. 4).

In step S5, the difference comparison/detection unit 14 detects the difference between the image information after the revision and the pre-registered image information before the revision. In this case, the image information after the revision and the image information before the revision are read out from the storage unit 16, and the difference between these pieces of image information is detected on a page or output paper sheet basis. In this case, a difference is detected for each output paper sheet, i.e., image information corresponding to two pages.

It is checked in step S6 whether or not a difference is detected. If a difference is detected, the image information of the detected portion is bitmapped in step S7. In this step, the printing information converting unit 15 performs bitmap processing of the image information corresponding to one output paper sheet (two pages, i.e., page 1 and page 2, in FIG. 3), in which the difference is detected, to convert the information into printing information. The flow then returns to step S5 to continuously perform difference comparison/detection of image information. In this case, difference comparison/detection is performed for image information corresponding to the next output paper sheet (e.g., page 3 and page 4). If it is determined in step S6 that no difference is detected, it is checked in step S8 whether or not the end of the image information (end flag) is detected. In this step, it is checked whether or not an end flag attached to the image information is detected. If an end flag is detected, it is determined that the end of the image information is detected.

If the end of the image information is not detected, i.e., no end flag is detected in step S8, the flow returns to step S5 to continuously perform difference comparison/detection. In this case, the above operation in steps S5 to S8 is repeated. If it is determined in step S8 that the end of the image information is detected, i.e., an end flag is detected, difference comparison/detection is finished. The flow then advances to step S9.

In step S9, the printing information of the different portion is transferred to the printer 20 through the I/F unit 17. Since only the printing information of the different portion is transferred to the printer 20, the amount of data transferred is smaller than in the prior art, and the data transfer time can be shortened.

In step S10, differential printing is executed by the printer 20 on the basis of the printing information transferred from the computer 10. When printing is completed by the designated print count, the image printing operation is terminated.

As described, in this embodiment, in performing differential printing, i.e., partly revising image information and printing only the revised portion, the computer 10 causes the difference comparison/detection unit 14 to detect the difference between the image information after the revision and the image information before the revision which is registered in advance, causes the printing information converting unit 15 to convert the image information of the portion in which the revision is detected into printing information, and transfers it to the printer 20. The printer 20 then prints an image on the basis of the transferred printing information.

With this operation, when differential printing is to be performed, the amount of data transferred from the computer 10 to the printer 20 can be reduced, and hence the data transfer time can be shortened. In addition, since the computer 10 converts image information into printing information, the load on the printer 20 as a shared device can be reduced, and the printing time can be shortened.

In addition, since only a difference can be printed, specifications or the like can be easily partly replaced. In this case, there is no need to print a large number of pages, and hence printing paper sheets can be saved. In addition, function setting can be performed by the printer driver, and imposition of a plurality of pages can be properly performed.

The above embodiment has exemplified the image printing system in which a plurality of computers 10 are connected to the printer 20 through the network 30. However, the present invention is not limited to this. For example, one computer 10 may be directly connected to the printer 20. Note that a unit obtained by physically integrating the computer 10 and printer 20 may also be used.

In addition, the above embodiment has exemplified the imposing of a plurality of pages. However, the present invention is not limited to this. The present invention can also be applied to general one-sided printing or two-sided printing.

What is claimed is:

1. An image printing system which causes a printing unit to output an image on the basis of input image information corresponding to a plurality of pages, comprising:
a printing information converting unit which converts the input image information corresponding to the plurality of pages into printing information;
a storage unit which stores image information corresponding to a plurality pages in advance;
a difference comparison/detection unit which compares the input image information corresponding to the plurality of pages with the image information corresponding to the plurality of pages stored in said storage unit on a page basis; and
a control unit which controls said printing unit to output the printing information converted by said printing information converting unit,
wherein page-based image information which is determined to be different by said difference comparison/detection unit is converted into printing information by said printing information converting unit, and said printing unit outputs the image information as an image on the basis of the converted printing information.

2. A system according to claim 1, wherein when image information corresponding to a plurality of pages is to be output onto one output paper sheet, all page-based image information which includes page-based image information which is determined to be different by said difference comparison/detection unit is converted into printing information by said printing information converting unit, and said printing unit outputs an image on the basis of the converted printing information.

3. An image printing system in which at least one information processing apparatus to which image information corresponding to a plurality of pages is input and an image printing apparatus including a printing unit which prints an image on the basis of the input image information corresponding to the plurality of pages are connected to each other through a network, said information processing apparatus including:
a printing information converting unit which converts the input image information corresponding to the plurality of pages into printing information;
a storage unit which stores image information corresponding to a plurality pages in advance;
a difference comparison/detection unit which compares the input image information corresponding to the plurality of pages with the image information corresponding to the plurality of pages stored in said storage unit on a page basis; and
a control unit which controls said printing unit of said image printing apparatus to output the printing information converted by said printing information converting unit,
wherein page-based image information which is determined to be different by said difference comparison/detection unit is converted into printing information by said printing information converting unit, and said printing unit outputs the image information as an image on the basis of the converted printing information.

4. A system according to claim 3, wherein
said difference comparison/detection unit compares the image information corresponding to the plurality of pages stored in said storage unit with revised image information corresponding to a plurality of pages, and detects image information of a revised page portion,
said printing information converting unit converts the image information of the revised page portion detected by said difference comparison/detection unit into printing information, and
said control unit outputs the printing information of the revised page portion to said image printing apparatus.

5. A system according to claim 3, wherein when image information corresponding to a plurality of pages is to be output onto one output paper sheet, all the page-based image information including page-based image information which is determined to be different by said difference comparison/detection unit is converted into printing information by said printing information converting unit, and an image is output from said printing unit of said image printing apparatus on the basis of the converted printing information.

6. An image printing system in which at least one information processing apparatus to which image information corresponding to a plurality of pages is input and an image printing apparatus including a printing unit which prints an image on the basis of the input image information corresponding to the plurality of pages are connected to each other through a network,
said information processing apparatus including:
a storage unit which stores image information corresponding to a plurality pages in advance; and
a difference comparison/detection unit which compares the input image information corresponding to the plurality of pages with the image information corresponding to the plurality of pages stored in said storage unit on a page basis;
said image printing apparatus including:
a printing information converting unit which converts the input image information corresponding to the plurality of pages into printing information; and
a control unit which controls said printing unit of said image printing apparatus to output the printing information converted by said printing information converting unit,
wherein page-based image information which is determined to be different by said difference comparison/detection unit is converted into printing information by said printing information converting unit, and said printing unit outputs the image information as an image on the basis of the converted printing information.

7. An image printing system in which at least one information processing apparatus to which image information corresponding to a plurality of pages is input and an image printing apparatus including a printing unit which prints an image on the basis of the input image information corresponding to the plurality of pages are connected to each other through a network,
said image printing apparatus including:
a printing information converting unit which converts the input image information corresponding to the plurality of pages into printing information;
a storage unit which stores image information corresponding to a plurality pages in advance;
a difference comparison/detection unit which compares the input image information corresponding to the plurality of pages with the image information corresponding to the plurality of pages stored in said storage unit on a page basis; and
a control unit which controls said printing unit of said image printing apparatus to output the printing information converted by said printing information converting unit,
wherein page-based image information which is determined to be different by said difference comparison/detection unit is converted into printing information by said printing information converting unit, and said printing unit outputs the image information as an image on the basis of the converted printing information.

8. An image-printing apparatus, which is connected, through a network, to at least one information processing apparatus to which image information corresponding to a plurality of pages is input, comprising:
printing information converting means for converting the input image information corresponding to the plurality of pages into the printing information; and
image printing means for, when the input image information corresponding to the plurality of pages includes a page which needs to be revised, printing images corresponding to a plurality of pages on the basis of printing information converted by said printing information converting means from image information from the information processing apparatus which revises the image information of the corresponding page and includes difference comparison/detection means for comparing the revised image information corresponding to the plurality of pages with the image information corresponding to the plurality of pages stored in said storage means on a page basis to detect a difference,
wherein page-based image information which is determined to be different by the difference comparison/detection means is converted into printing information by said printing information converting means, and said image printing means outputs the converted printing information.

9. An apparatus according to claim 6, wherein said image printing apparatus prints an image on an output paper basis on the basis of the printing information of a revised portion which is converted by said printing information converting means.

10. An apparatus according to claim 6, wherein when image information corresponding to a plurality of pages is to be output, onto one output paper sheet, the image information corresponding to the plurality of pages is arranged on one surface or obverse and reverse surfaces of one output paper sheet.

11. An image printing method of outputting an image on the basis of input image information corresponding to a plurality of pages, comprising:
the printing information converting step of converting the input image information corresponding to the plurality of pages into printing information;
the storage step of storing image information corresponding to a plurality pages; and
the comparison step of comparing, the input image information corresponding to the plurality of pages with the image information corresponding to the plurality of pages stored in the storage unit on a page basis,
wherein page-based image information which is determined to be different in the comparison step is converted into printing information in the printing information converting step, and is output as an image.

12. A computer-readable storage medium which stores a program for controlling an information processing unit to which image information corresponding to a plurality of pages is input, the program including
the printing information converting step of converting the input image information corresponding to the plurality of pages into printing information;
the storage step of storing image information corresponding to a plurality pages; and
the comparison step of comparing the input image information corresponding to the plurality of pages with the image information corresponding to the plurality of pages stored in the storage step on a page basis,
wherein the information processing unit is controlled to convert page-based image information which is determined to be different in the comparison step into printing information in the printing information converting step, and to output the converted printing information.
